(19) United States
(12) Patent Application Publication
(10) Pub. No.: US 2009/0063239 A1
(43) Pub. Date: Mar. 5, 2009

(54) Method and Apparatus for Providing an Electronic Calendar with an Indication of Timeslot Availability Dependent on the Importance of a Requester

(75) Inventors: Joseph G. Baron, Raleigh, NC (US); Frank Battaglia, Raleigh, NC (US); Jerrold Martin Heyman, Raleigh, NC (US); Michael Leonard Nelson, Raleigh, NC (US); Andrew Geoffrey Tonkin, Morrisville, NC (US)

Correspondence Address: MARK P. KAHLER, 8101 VAILVIEW COVE, AUSTIN, TX, 78750, US

(73) Assignee: IBM Corporation, Austin, TX (US)

(21) Appl. No.: 11/847,493

(22) Filed: Aug. 30, 2007

(51) Int. Cl. G06F 9/46

(52) U.S. Cl. 705/9

(57) ABSTRACT

An electronic calendar scheduling system is disclosed in which a participant schedules an event in a particular timeslot. In one embodiment, the participant may associate a timeslot importance level with the particular timeslot. When a requester later sends the participant a request to schedule another event during the already scheduled particular timeslot, the system informs the requester that the particular timeslot is either available or unavailable depending on the importance of the requester in a predetermined organization hierarchy. In one embodiment, if the requester importance level is greater than the timeslot importance level, then the system informs the requester that the already scheduled timeslot is available. Otherwise, the system informs the requester that the already scheduled timeslot is unavailable.

### TECHNICAL FIELD OF THE INVENTION

The disclosures herein relate generally to calendaring systems, and more particularly to electronic calendaring systems.

### BACKGROUND

Calendar software is available that runs on networked information handling systems (IHSs) to enable users to more easily schedule meetings and events over a network rather than by telephone voice conversation. For example, several local client IHSs connect via a network to a server IHS that includes server calendar software. Each client IHS includes client calendar software. Alternatively, a number of networked IHSs may employ calendar software on a peer-to-peer basis to access one another's calendars. A requester, such as a meeting leader or organizer, may use the calendar software to send meeting invitations or requests that designate a particular date, time, duration and place to prospective meeting participants. The prospective participants may accept or decline the invitations depending on their available free time.

It is very helpful to access the calendars of the prospective participants when planning a meeting to see if the prospective participants are available for a meeting at a particular date and time. Conventional calendar software typically provides two levels of timeslot availability. A particular timeslot is either free (no meeting or event scheduled) or busy (one or more meetings or events scheduled for that time). In some calendar systems, the user may designate timeslots as private. This practice makes the timeslot appear as busy without displaying the event that corresponds to that timeslot. Still other calendar systems may allow the calendar user to “pencil in” a particular timeslot that contains information visible only to the user and that appears as free to everyone else who may access the user's calendar.

In the real world, whether a particular timeslot is in fact truly free or busy may depend on the position of the requester within an organization. For example, a calendar user may mark a particular timeslot in his or her electronic calendar as busy for a meeting with a peer to discuss a new circuit design. However, the calendar user's manager, acting as a requester, may request a meeting during the same timeslot which appears to the manager as a busy timeslot. The calendar user, acting as a prospective participant, may accept the manager's request for a meeting during the previously scheduled busy timeslot and manually reschedule the meeting with the peer. In this scenario, the timeslot was really available to the manager because the manager's request was more important than the previously scheduled meeting with the peer.

Conventional electronic calendar systems may not reflect the true availability of a prospective participant for a meeting or event during a particular timeslot. What is needed is a method of gathering availability or free time information from prospective participants that addresses the above problems.

### SUMMARY

Accordingly, in one embodiment, a method of scheduling a meeting in an electronic calendar is disclosed. The method includes scheduling, by a participant IHS, a first event during a particular timeslot in the electronic calendar, thus providing an already scheduled timeslot. The method also includes associating, by the participant IHS, a timeslot importance level with the already scheduled timeslot. The method further includes receiving, by the participant IHS, a request from a requester IHS to schedule a second event during the already scheduled timeslot, the request including a requester importance level of the requester in an organizational hierarchy. The method still further includes transmitting, by the participant IHS, a response to the requester IHS, the response being a timeslot available response if the requester importance level is higher than the timeslot importance level of the already scheduled timeslot, the response otherwise being a timeslot unavailable response.

In another embodiment, a method of scheduling a meeting in an electronic calendar is disclosed. The method includes scheduling, by a participant IHS, a first event during a particular timeslot in the electronic calendar, thus providing an already scheduled timeslot. The method also includes receiving, by the participant IHS, a request from a requester IHS to schedule a second event during the already scheduled timeslot. The method further includes transmitting, by the participant IHS, a response to the requester IHS, the response being a timeslot available response if a requester associated with the requester IHS exhibits a position in an organizational hierarchical higher than a position of a participant associated with the participant IHS, the response otherwise being a timeslot unavailable response.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 is a block diagram of one embodiment of the disclosed calendar scheduling system.

FIG. 2A is a representation of a calendar window that the disclosed calendar scheduling system employs.

FIG. 2B is a representation of a participant meeting request form that the disclosed meeting scheduling system employs.

FIG. 3 is a representative calendar window that the disclosed meeting scheduling system employs.

FIG. 4A is timeslot importance level table that the disclosed meeting scheduling system employs.

FIG. 4B is requester importance level table that the disclosed meeting scheduling system employs.

FIG. 5 is a representative calendar window that shows preemption of a previously scheduled meeting by a higher importance level requester than the participants in the previously scheduled meeting.

FIG. 6 is a flowchart that depicts one embodiment of the disclosed calendaring methodology.

FIG. 7 is a representative organization chart including requesters and respective requester importance levels that the disclosed calendaring methodology employs.

FIG. 8 is block diagram of an information handling system (IHS) that the disclosed calendar scheduling system may employ as calendar owner IHSs, client IHSs and server IHSs.

### DETAILED DESCRIPTION

The disclosed methodology and apparatus enables an electronic calendar to display different availability states (free/busy) depending on the position of a requester in an organizational hierarchy. In one embodiment, an ordered numerical class hierarchy classifies timeslots in an electronic calendar according to particular requester position types that may access each timeslot.

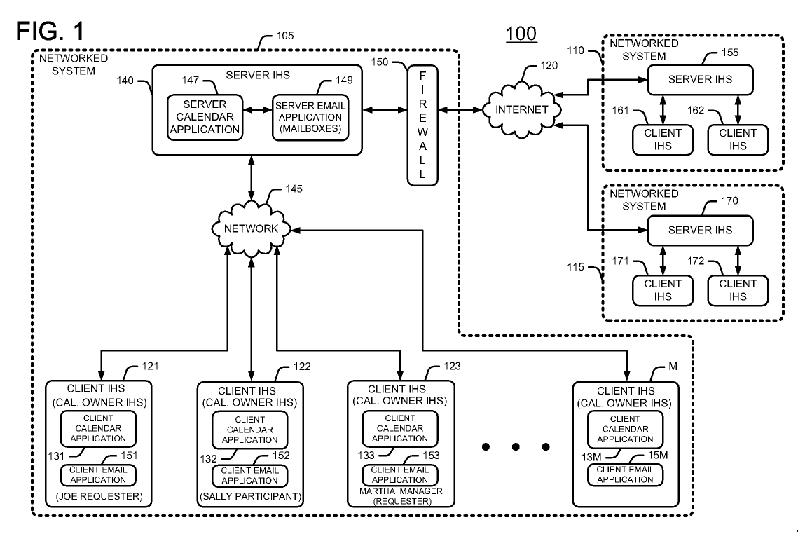

FIG. 1 is a block diagram of one embodiment of electronic calendar scheduling system 100. While the disclosed methodology may be practiced in a client-server based calendar configuration, it is also possible to practice the methodology in other configurations such as peer-to-peer. However, the embodiment of FIG. 1 shows system 100 as a client-server based calendar system. System 100 includes a number of server information handling systems (IHSs) and a number of client IHSs. In actual practice, these IHSs may take many forms. For example, an IHS may take the form of a desktop, portable, laptop, notebook, minicomputer or mainframe computer or other form factor computer or data processing system. An IHS may also take other form factors such as a gaming device, a personal digital assistant (PDA), a portable telephone device, a communication device or other devices that include a processor and memory. In the representative system 100 of FIG. 1, system 100 includes a networked system 105 within a particular organization or business entity, and further includes networked systems 110 and 115 in other organizations or business entities. Networked systems 105, 110 and 115 couple together via the Internet 120.

Networked system 105 includes client IHSs 121, 122, 123 . . . M, wherein M is the total number of IHSs in networked system 105. Client IHSs 121, 122, 123 . . . M respectively include client calendar applications 131, 132, 133, . . . 13M that each communicate with a server IHS 140 via a network 145 therebetween, as shown in FIG. 1. Server IHS 140 includes server calendar application 147 and server email application 149 with client mailboxes therein. Server email application 149 includes a respective server mailbox for each of client IHSs 121, 122, 123 . . . M. Networked system 105 further includes a firewall 150 that couples the server IHS 140 to the Internet 120. In this manner, client IHSs 121, 122, 123 . . . M and the server IHS 140 may communicate with server IHSs and client IHSs external to the organization or business entity to which networked system 105 corresponds. The dashed line 105 in FIG. 1 corresponds not only to networked system 105 but also to the organization or business entity that employs networked system 105. Client IHSs 121, 122, 123 and M respectively include client email applications 151, 152, 153 and 15M that communicate via network 145 with server email application 149 in server IHS 140. In this manner, client IHSs 121, 122, 123 and M may communicate among one another and with external IHSs via email.

Networked systems 110 and 115 couple to networked system 105 via the Internet 220 or other network. The dashed lines 110 and 115 indicate not only networked systems 110 and 115, but also the respective organizations or business entities that employ networked systems 110 and 115. In more detail, networked system 110 includes a server IHS 155 that couples to client IHSs 161 and 162. Networked system 115 includes server IHS 170 that couples to client IHSs 171 and 172.

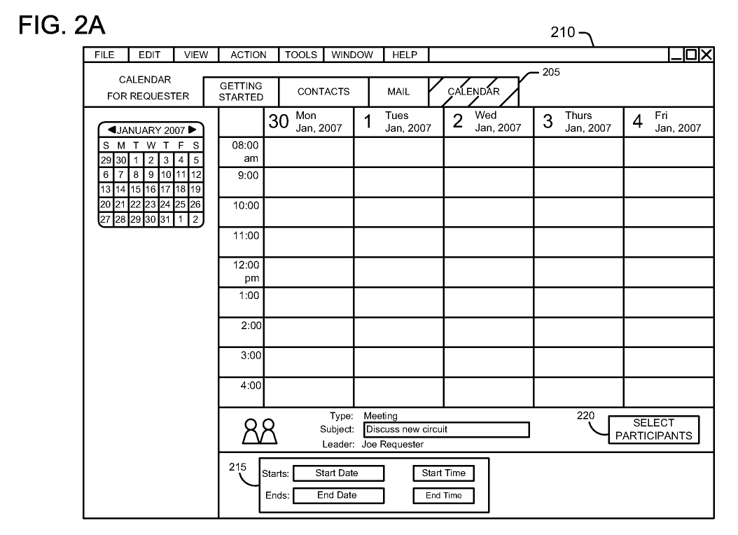

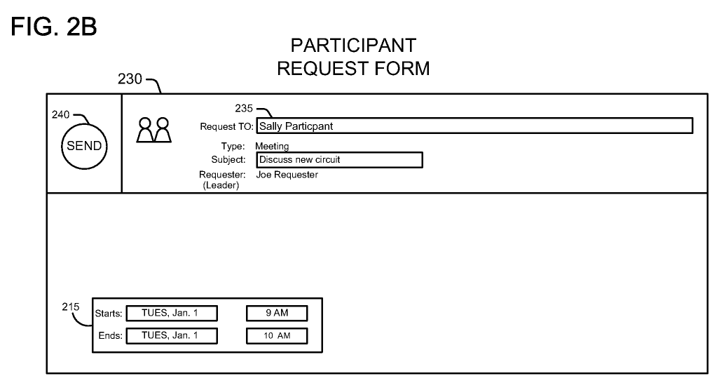

A meeting organizer or requester desires to set up a meeting or event using calendar system 100. In this particular example, the user of client IHS 121 is the requester (Joe Requester) and the user of client IHS 122 is the prospective participant (Sally Participant), as seen in FIG. 1. The requester activates the client calendar application 131 on client IHS 121 and selects a calendar tab 205 shown in FIG. 2A. In response, client IHS 121 displays a calendar window 210. The requester enters the start date, start time, end date, end time of the meeting or event in schedule event box 215. In other words, the requester specifies a particular timeslot for the event or meeting, for example January 1, 9 am-10 am.

To select participants for the meeting, the requester selects the “select participants” box 220. In response, client calendar application 131 of client IHS 121 displays the participant meeting request form 230 of FIG. 2B. The requester adds the name of the prospective participant, Sally Participant, in “send request to” box 235. The requester then selects send button 240 and, in response, client calendar application 131 transmits a meeting request to client calendar application 132 in client IHS 122. In this example, the calendar owner of client IHS 122, namely Sally Participant, accepts the meeting request. Client calendar application 132 sends a response back to client IHS 121 accepting the meeting during the particular timeslot that the meeting request specified.

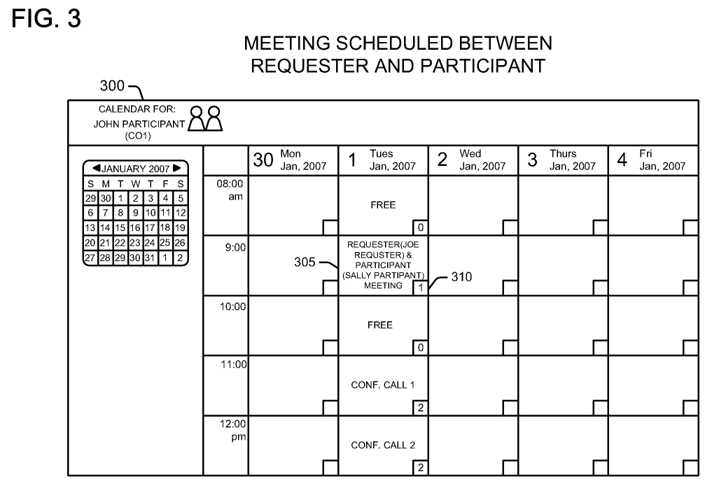

Client calendar application 131 receives the response and displays the calendar window 300 of FIG. 3 to the requester at client IHS 121. Calendar window 300 includes a timeslot 305 that depicts both Requester (Joe Requester) and Participant (Sally Participant) in a meeting scheduled for Tuesday, January 1, between 9 am and 10 am. Each timeslot in calendar window 300 includes a respective associated timeslot importance level field such as timeslot importance level field 310 into which the requester, namely the calendar owner, may place a numerical timeslot importance level. This timeslot level number indicates the importance level that another requester must exceed to access or preempt the meeting in the already scheduled timeslot 305. In this particular example, timeslot 305 includes a respective associated timeslot level field 310 into which the requester types a “1” indicating a 1st timeslot importance level. The significance of the selected timeslot importance level is discussed in more detail below.

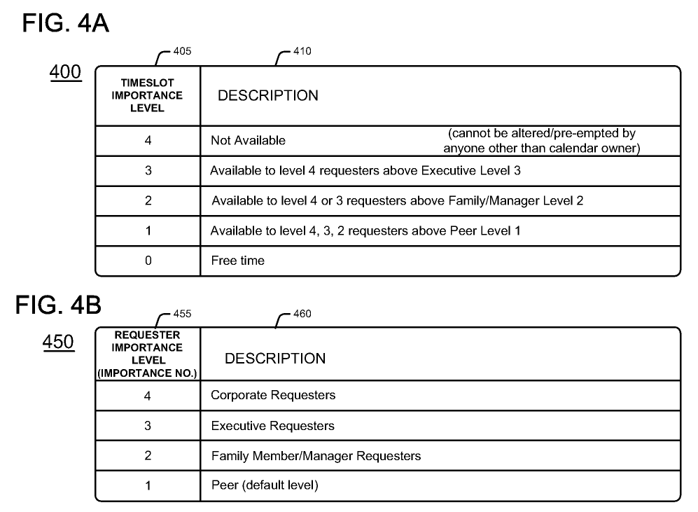

FIG. 4A is a table 400 that shows multiple possible timeslot importance levels 405 and respective descriptions 410. FIG. 4B is a table 450 that shows requester importance levels 455 and respective descriptions 460. Requester importance level “4” indicates the highest importance level requesters, namely “corporate” requesters in this particular example. Requester importance level “3” indicates the next highest importance level requesters, namely “executive” requesters in this particular example. Requester importance level “2” indicates the next highest importance level requesters, namely “family member and manager” requesters in this particular example. Requester importance level “1” indicates the lowest importance level requesters, namely “peer” requesters in this particular example. When a higher importance level requester accesses a timeslot in a lower importance level calendar owner's calendar that includes an already scheduled meeting, that timeslot will appear as “available” to the higher level requester. However, if a peer, namely a requester with the same importance level as the calendar owner, accesses the timeslot that includes the already scheduled meeting, then that timeslot appears as busy. Thus, the availability of a particular timeslot that includes an already scheduled meeting varies with the importance level of the requester. Higher level requesters, see more available time than lower level requesters.

Returning to FIG. 4A, the calendar owner at a particular client IHS or other user IHS, may rate each timeslot having a scheduled event on their calendar with a timeslot importance level such as shown in table 400. The IHS user performs this rating or classifying by inserting one of the timeslot importance levels 405 of table 400 into a timeslot level field, such as 310, in the calendar 300 of FIG. 3. Table 400 shows that a timeslot importance level of “0” indicates free time. In one embodiment, all timeslot level fields in calendar 300 receive a default timeslot importance level of 0 to indicate free time that any level requester may access to see if it available. If the user assigns a timeslot importance level of “1” from Table 400 to a particular timeslot, then the client IHS calendar application software, such as 131, makes the particular timeslot appear as available to requesters with a higher requester importance level, namely 2, 3, or 4. However, if the user assigns a timeslot importance level of “2” from Table 400 to a particular timeslot, then the client IHS calendar application software makes the particular timeslot appear as available to requesters with a higher requester importance level, namely 3 or 4. In another scenario, if the user assigns a timeslot importance level of “3” from Table 400 to a particular timeslot, then the client IHS calendar application software makes the particular timeslot appear as available to requesters with a higher requester importance level, namely 4. In yet another scenario, if the user assigns a timeslot importance level of “4” from Table 400 to a particular timeslot, then the timeslot is absolutely not available in this embodiment. Client calendar software such as 131 and/or server calendar application 147 will not allow any user other than the calendar owner to see a timeslot with an importance level of “4” as available. Moreover, in one embodiment, the client calendar software will only allow the calendar owner to alter a timeslot with importance level of “4”.

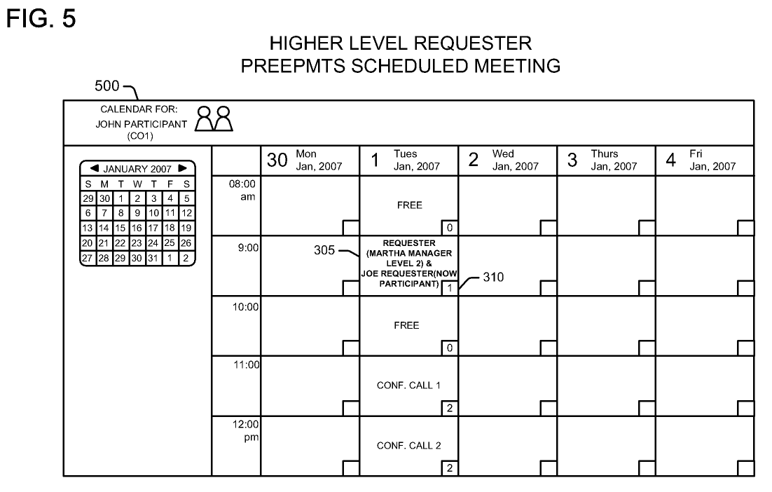

Returning to FIG. 3, calendar window 300 shows a scheduled meeting between requester (Joe Requester) and participant (Sally Participant) in timeslot 305. In this particular example, the requester rated the meeting with a timeslot importance level of “1” that indicates the timeslot is available to other requesters with a requester level of 4, 3 or 2. Other requesters with a lower requester importance level than importance level 2 who try to schedule a meeting with Joe Requester will see this timeslot as busy. In another scenario, at a client IHS a new requester with an importance level of “2” accesses the calendar of Joe Requester who uses client IHS 121. The new requester is a manager (Martha Manager) and user of client IHS 123 in this particular example. While Joe Requester was a requester in the previous example, Joe Requester is now a participant in the transaction with the manager of importance level “2” and the manager is the requester. This is so because the manager is now the person requesting a meeting with Joe Requester who is a party in the already scheduled meeting in timeslot 310 as shown in FIG. 3. Calendar software, either at the server calendar application level or local calendar application level, tests the importance level of the manager as requester to determine if that importance level is greater than the importance level “1” that Joe Requester assigned to the timeslot 310. In this case, the importance level “2” of the manager (Martha Manager) exceeds the timeslot importance level “1” of the subject timeslot 310. Thus, the manager as requester sees the subject timeslot as available or free. Calendar system 100 updates timeslot 305 to now show the manager (Martha Manager) and Joe Requester as participants in a meeting at that time, as depicted in FIG. 5. However, if the new requester had an importance level of “1”, that new requester would see the timeslot as “busy” and system 100 would not allow such a requester to alter the timeslot. In another embodiment, after Martha Manager (requester importance level 2) preempted the already scheduled meeting (timeslot importance level 1) in timeslot 305, Martha Manager may select another timeslot importance level for timeslot importance field 310, such as a timeslot importance of “3”, for example. In that case, another manager at requester importance level “4” could preempt the meeting at timeslot importance level “3”; however, requesters at requester levels “3”, “2” and “1” would see the timeslot as busy.

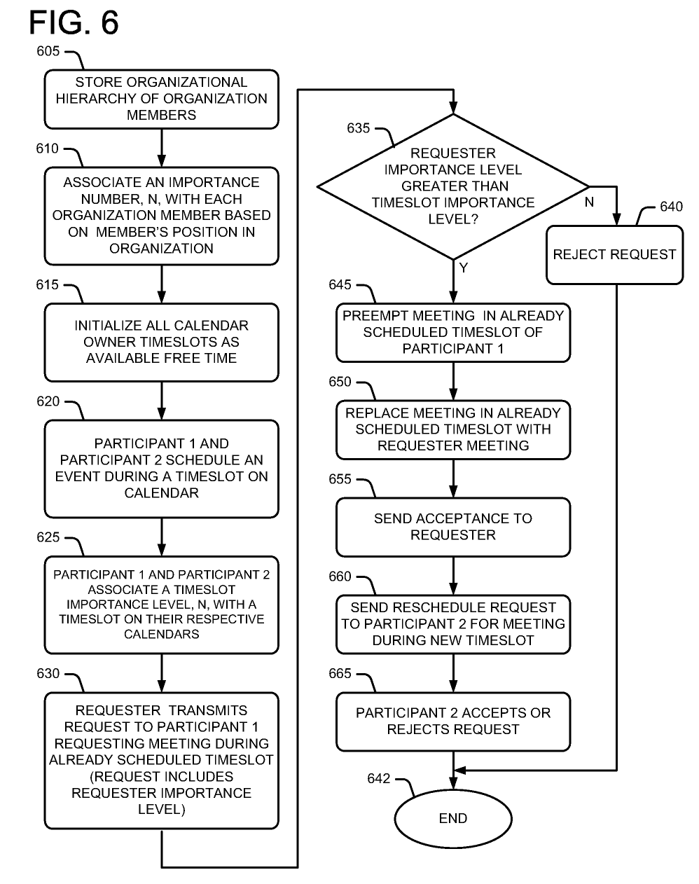

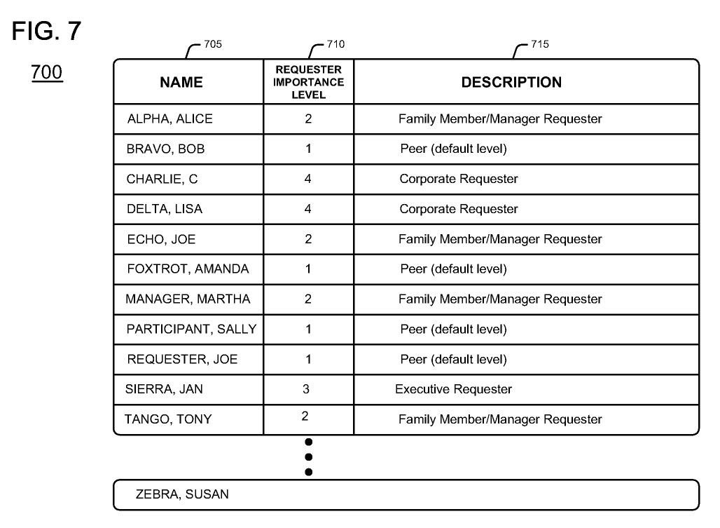

FIG. 6 is a flowchart that shows a representative process flow as calendar system 100 performs the disclosed electronic calendar methodology. Portions of the disclosed process may perform on a requester's IHS, while other portions perform on a participant's IHS. In one embodiment, the disclosed process may execute in a client server system while in other embodiments the disclosed methodology may execute on IHSs configured in a peer-to-peer relationship. For simplicity, the peer-to-peer embodiment is discussed with reference to the FIG. 6 flowchart. Referring again momentarily to FIG. 1, calendar system 100 includes calendar owner IHSs 121, 122, 123 . . . M. Each calendar owner IHS 121, 122, 123 . . . M is a peer of the other calendar owner IHSs 121, 122, 123 . . . M under network 145. Later discussion will focus on IHSs 121, 122, 123 . . . M as client IHSs operating under server IHS 140. However, a peer-to-peer methodology is now discussed. The calendar owner, namely the operator of IHS 121, for example, is a member of an organizational hierarchy with individuals at lower levels reporting to managers at higher levels. Representative calendar owner IHS 121 stores an organizational hierarchy table or database 700 such as seen in FIG. 7 in calendar application 131, as per block 605. Organizational hierarchy table 700 associates the names 705 of organization members (requesters) with respective requester importance levels, namely an importance number, N, based on the position of each requester in the organization, as per block 610. Table 700 also includes a description 715 of the member's or requester's level. Descriptions 715 correspond to the descriptions 460 in table 450 on FIG. 4B.

Returning to the flowchart of FIG. 6, system 100 initializes all calendar owner timeslots to display as “free time”, as per block 615. To achieve this in one embodiment, the calendar application in each of calendar owner IHSs 121, 122, 123, . . . N, sets the timeslot level field, such as field 310 in FIG. 5 of that IHS, to a value of “0”. Such a “0” value in the timeslot level field signifies that the timeslot is “free time” that is viewable and available to all requesters.

For discussion purposes, assume that 2 calendar owners (for example the owners of calendar owner IHS 121 and calendar owner IHS 122) schedule a meeting during a particular timeslot, as per block 620. Once scheduling of the meeting in the particular timeslot is complete, both individuals are participants, namely Joe Requester becomes Participant 1 and Sally Participant becomes Participant 2. Assume however that before scheduling the meeting during the particular timeslot, Joe Requester was the requester and Sally Participant was the participant. Once Joe Requester schedules the meeting with Sally Participant as seen in FIG. 3, Joe Requester assigns a timeslot importance level of N=1 to timeslot importance field 310 in calendar application 132 of his calendar IHS 121, as per block 625. Sally Requester may also chose to select a timeslot importance level of 1 to the timeslot on the calendar application 132 on her calendar owner IHS 122, as per block 625. Again, now that meeting scheduling in the particular timeslot is complete, Joe Requester becomes Participant 1 and Sally Participant becomes Participant 2.

Now assume that another requester, namely a manager (Martha Manager) with a requester importance level of 2, sends a request for a meeting from her calendar owner IHS 123 to Joe Requester (now Participant 1) at calendar owner IHS 121, as per block 630. The request includes the name of the requester, the requester importance level, the start date, the start time, the end date and the end time. In this example, the request is for Joe Requester to participate in a meeting with Martha Manager during the already scheduled timeslot. The calendar application 131 of calendar owner IHS 121 receives the request and performs a test, as per decision block 635, to determine if the requester importance level (namely 2) of Martha Manager in the request is greater or higher than the timeslot importance level (namely 1) that Joe Requester specified in timeslot level field 310 when he initially scheduled the meeting with Sally Participant. If the requester importance level of the manager requester or other requester is not greater than the timeslot importance level (namely 1), then calendar application 133 in the requester's calendar client IHS 123 rejects the request to pre-empt the already scheduled timeslot, as per reject request block 640. The meeting during the particular timeslot remains scheduled at its original time and is unaffected by the request. The process then ends at end block 642.

However, in the present example the manager or requester has a requester importance level of “2”. Thus, at decision block 635, the current requester importance level (namely 2) is greater than the timeslot importance level (namely 1). The manager requester exhibits a higher importance than the timeslot importance, and thus the manager's request for a meeting preempts the already scheduled meeting in that timeslot, as per block 645. In this case, the meeting that the manager requests replaces the already scheduled meeting between Participant 1 (Joe Requester) and Participant 2 (Sally Participant), as per block 650. The calendar application 131 generates a calendar window 500 on calendar client IHS 121 that now appears as shown in FIG. 5 to reflect the preemption of the previously scheduled meeting. Timeslot 305 now shows the meeting between the level 2 manager requester (Martha Manager) and Joe Requester. Joe Requester, now acting as Participant 1, sends an acceptance of the manager's meeting request back to the manager's IHS 123, as per block 655. The calendar application 131 in calendar owner's IHS 121 (namely Participant 1's IHS) generates and sends a meeting rescheduling request at a new time to Participant 2 at calendar owner IHS 122, as per block 660. Participant 2 accepts or rejects this meeting request at calendar owner IHS 122, as per block 655. With the rescheduling of the pre-empted meeting complete, process flow ends at end block 642.

While the flowchart of FIG. 6 discussed above refers to a peer-to-peer embodiment wherein calendar owner IHSs 121, 122, 123, . . . 12M perform the operations described in the flowchart, a client-server embodiment is also possible, such as shown in FIG. 1. In that case, server IHS 140 performs some functions in the FIG. 6 flowchart that the peers, namely the calendar client IHSs, performed in the peer-to-peer embodiment. For example, in a client-server embodiment, server calendar application 147 stores the organizational hierarchy table or database 700 such as seen in FIG. 7, as per block 605. This server-based organizational hierarchy table 700 associates the names 705 of organization members (requesters) with respective requester importance levels, namely an importance number, N, based on the position of each requester in the organization, as per block 610. Client calendar applications 131, 132, 133, . . . 13M may maintain local calendars while updating a master calendar for each client IHS user in server calendar application 147 in server IHS 140. Lotus Notes application software, modified by the teachings herein, is an example of client and server calendar application software that client and server IHSs may employ to practice the disclosed meeting scheduling methodology. (Lotus Notes is a trademark of the IBM Corporation.)

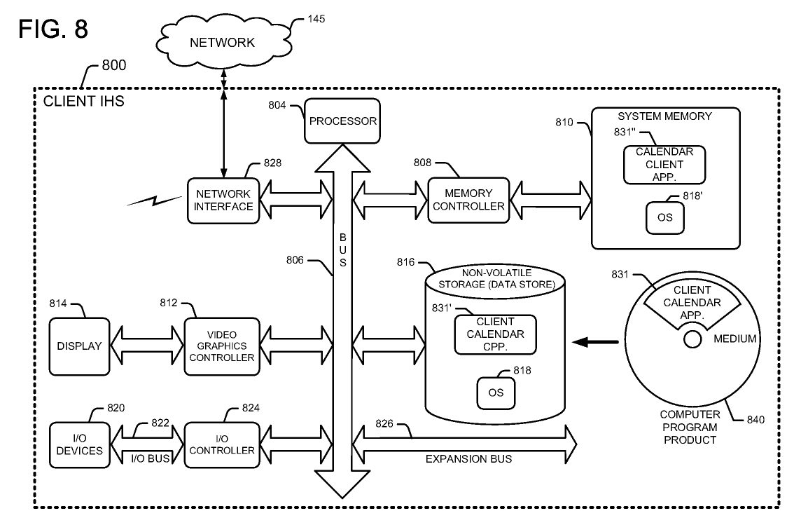

FIG. 8 shows an information handling system (IHS) 800 that system 100 may employ as IHSs 121, 122, 123, . . . M. IHS 800 includes calendar application software, such as calendar applications 131, 132, 133, . . . 13M, that enables the meeting organizer or requester to send a meeting request from a requester IHS to a prospective participant's IHS. In this particular example, calendar client application 831 represents calendar applications 131, 132, 133, . . . 13M. IHS 800 includes a processor 804 that couples to a bus 806. A memory controller 808 couples system memory 810 to bus 806. A video graphics controller 812 couples display 814 to bus 806. IHS 800 includes nonvolatile storage 816, such as a hard disk drive, CD drive, DVD drive, or other nonvolatile storage that couples to bus 806 to provide client IHS 800 with permanent storage of information. Nonvolatile storage 816 is a form of data store. An operating system (OS) 818 loads from nonvolatile storage 816 to memory 810 as OS 818′ to govern the operation of IHS 800. I/O devices 820, such as a keyboard and a mouse pointing device, couple via I/O bus 822 and I/O controller 824 to bus 806. One or more expansion busses 826, such as USB, IEEE 1394 bus, ATA, SATA, PCI, PCIE and other busses, couple to bus 806 to facilitate the connection of peripherals and devices to client IHS 800. A network interface 828 couples to bus 806 to enable IHS 800 to connect by wire or wirelessly to network 145 and other client and server IHSs. Network 145 may be a local area network (LAN), a wide area network (WAN), an internet protocol (IP) network, or other connective apparatus. IHS 800 may take many forms. For example, IHS 800 may take the form of a desktop, server, portable, laptop, notebook, or other form factor computer or data processing system. IHS 800 may also take other form factors such as a personal digital assistant (PDA), a gaming device, a portable telephone device, a communication device or other devices that include a processor and memory.

Client IHS 800 may employ a compact disk (CD), digital versatile disk (DVD), floppy disk, external hard disk or virtually any other digital storage medium as medium 840. Medium 840 stores client calendar application 831 thereon. A user or other entity installs client calendar application 831 on IHS 800 prior to usage of this application. The designation, client calendar application 831′, describes client calendar application 831 after installation on client IHS 800. The designation, client calendar application 831″, describes client calendar application 831 after client IHS 800 loads the client calendar application into system memory 810 for execution. System 100 may employ client calendar application 831 as client calendar applications 131, 132, 133, . . . M.

Those skilled in the art will appreciate that the various structures disclosed can be implemented in hardware or software. Moreover, the methodology represented by the blocks of the flowchart of FIG. 6 may be embodied in a computer program product, such as a media disk, media drive or other media storage such as computer program product medium 840 of FIG. 8.

In one embodiment, the disclosed methodology is implemented as a calendar application, namely sets of instructions (program code) in a code module which may, for example, be resident in system memory 810 of IHS 800 of FIG. 8. Until required by IHS 800, the set of instructions may be stored in another memory, for example, non-volatile storage 816 such as a hard disk drive, or in a removable memory such as an optical disk or floppy disk, or downloaded via the Internet or other computer network. Thus, the disclosed methodology may be implemented in a computer program product for use in a computer such as IHS 800. It is noted that in such a software embodiment, code that carries out the functions depicted in the FIG. 6 flow chart may be stored in system memory 810 while such code is being executed. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

The foregoing discloses a methodology and apparatus for scheduling events on an electronic calendar wherein the availability to a requester of a particular timeslot on the calendar depends on the relative level of importance of the requester with respect to the level of importance of a participant associated with the particular timeslot.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

We claim:

1. A method of scheduling a meeting in an electronic calendar, comprising:
scheduling, by a participant IHS, a first event during a particular timeslot in the electronic calendar, thus providing an already scheduled timeslot;
associating, by the participant IHS, a timeslot importance level with the already scheduled timeslot;
receiving, by the participant IHS, a request from a requester IHS to schedule a second event during the already scheduled timeslot, the request including a requester importance level of the requester in an organizational hierarchy; and
transmitting, by the participant IHS, a response to the requester IHS, the response being a timeslot available response if the requester importance level is higher than the timeslot importance level of the already scheduled timeslot, the response otherwise being a timeslot unavailable response.

2. The method of claim 1, wherein the associating step is performed by a participant inputting to the participant IHS the timeslot importance level to be associated with the already scheduled timeslot.

3. The method of claim 1, wherein the response includes a notice that the already scheduled timeslot is already scheduled for the first event.

4. The method of claim 3, further comprising:
receiving, by the requester IHS, the response;
confirming, by the requester IHS, that the requester IHS still requests that the second event be scheduled during the already scheduled timeslot, thus preempting the first event in the already scheduled timeslot.

5. The method of claim 4, further comprising:
transmitting, by the participant IHS, a notice to participants in the first event that the first event is preempted.

6. The method of claim 5, further comprising:
transmitting, by the participant IHS, a notice to participants in the first event that proposes rescheduling the first event in another timeslot.

7. The method of claim 1, further comprising storing the electronic calendar on a server information handling system.

8. The method of claim 1, further comprising storing the electronic calendar on a one client information handling system.

9. The method of claim 1, wherein the organizational hierarchy exhibits a plurality of importance levels.

10. A method of scheduling a meeting in an electronic calendar, comprising:
scheduling, by a participant IHS, a first event during a particular timeslot in the electronic calendar, thus providing an already scheduled timeslot;
receiving, by the participant IHS, a request from a requester IHS to schedule a second event during the already scheduled timeslot; and
transmitting, by the participant IHS, a response to the requester IHS, the response being a timeslot available response if a requester associated with the requester IHS exhibits a position in an organizational hierarchical higher than a position of a participant associated with the participant IHS, the response otherwise being a timeslot unavailable response.

11. The method of claim 10, further comprising:
associating, by the participant IHS, an importance level with the already scheduled timeslot prior to the receiving step, the importance level of the already scheduled timeslot being determined by the importance of a participant associated with the participant IHS within the organizational hierarchy.

12. The method of claim 10, wherein the response includes a notice that the already scheduled timeslot is already scheduled for the first event.

13. The method of claim 12, further comprising:
receiving, by the requester IHS, the response;
confirming, by the requester IHS, that the requester IHS still requests that the second event be scheduled during the already scheduled timeslot, thus preempting the first event in the already scheduled timeslot.

14. The method of claim 13, further comprising:
transmitting, by the participant IHS, a notice to participants in the first event that the first event is preempted.

15. The method of claim 14, further comprising:
transmitting, by the participant, a notice to participants in the first event that proposes rescheduling the first event in another timeslot.

16. The method of claim 10, further comprising storing the electronic calendar on a server information handling system.

17. The method of claim 10, further comprising storing the electronic calendar on a client information handling system.

18. The method of claim 10, wherein the organizational hierarchy exhibits a plurality of importance levels.

19. A computer program product stored on a computer operable medium for scheduling a meeting in an electronic calendar, the computer program product comprising a calendar client application that includes:
instructions for scheduling by a participant IHS a first event during a particular timeslot in the electronic calendar, thus providing an already scheduled timeslot;
instructions for associating by the participant IHS a timeslot importance level with the already scheduled timeslot;
instructions for receiving by the participant IHS a request from a requester IHS to schedule a second event during the already scheduled timeslot, the request including a requester importance level of the requester in an organizational hierarchy; and
instructions for transmitting by the participant IHS a response to the requester IHS, the response being a timeslot available response if the requester importance level is higher than the timeslot importance level of the already scheduled timeslot, the response otherwise being a timeslot unavailable response.

20. The computer program product of claim 19, wherein the instructions for associating include instructions for enabling a participant to input to the participant IHS the timeslot importance level to be associated with the already scheduled timeslot.
